(19) United States
(12) Patent Application Publication
(10) Pub. No.: US 2009/0213188 A1
(43) Pub. Date: Aug. 27, 2009

(54) METHOD OF MANUFACTURING AN ACTUATOR APPARATUS, A METHOD OF MANUFACTURING A LIQUID JET HEAD AND A LIQUID JET APPARATUS

(75) Inventors: Masato Shimada, Chino-shi (JP); Kazushige Hakeda, Shiojiri-shi (JP); Tsutomu Nishiwaki, Azumino-shi (JP); Eiju Hirai, Fujimi-machi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/370,898

(22) Filed: Feb. 13, 2009

(30) Foreign Application Priority Data
Feb. 14, 2008 (JP) 2008-033794
Dec. 25, 2008 (JP) 2008-330725

(51) Int. Cl. C23F 1/02; B41J 2/045

(52) U.S. Cl. 347/71; 216/16

(57) ABSTRACT

A method of manufacturing an actuator apparatus includes forming, on the base plate, a test pattern that is electrically discontinuous with the electrodes of the piezoelectric element and has the same layer as the lower electrode, the test pattern having the lower electrode with the upper electrode and the piezoelectric material layer removed by etching, and measuring electric resistance of the lower electrode of the test pattern to acquire the etch amount of the lower electrode when the piezoelectric element is formed.

### CROSS REFERENCES TO RELATED APPLICATIONS

The present invention contains subject matter related to Japanese Patent Application Nos. 2008-33794 and 2008-330725 filed in the Japanese Patent Office on Feb. 14, 2008 and Dec. 25, 2008, the entire contents of which are incorporated herein by reference.

### BACKGROUND OF THE INVENTION

1. Field of the Invention

The present invention relates to a method of manufacturing an actuator apparatus, a method of manufacturing a liquid jet head, and a liquid jet apparatus.

2. Description of the Related Art

When an upper electrode and a piezoelectric material layer are etched simultaneously, the surface of a lower electrode is also overetched. The lower electrode forms a part of a vibrating plate. If the overetch amount of the lower electrode varies, a variation in an ink ejection amount may occur. That is, if the overetch amount of the lower electrode is large, the lower electrode (vibrating plate) is thinned, and a displacement increases. The increase in the displacement causes an increase in the ink ejection amount. If the overetch amount of the lower electrode is small, the lower electrode is thickened, and the displacement decreases. The decrease in the displacement causes a decrease in the ink ejection amount.

The overetch amount of the lower electrode easily changes due to a change in environment, such as temperature or humidity, or a change in output power of an etching apparatus. In order to manufacture a stable product, it is necessary to grasp the overetch amount of the lower electrode.

If the overetch amount of the lower electrode varies between a plurality of ink jet type recording heads, when a plurality of ink jet type recording heads are combined to form a head unit, a variation occurs in the ink ejection characteristic of the head unit.

The overetch amount of the lower electrode is measured only by cutting a piezoelectric element. This measurement method causes an increase in costs.

Such a problem occurs in a liquid jet head that jets a liquid other than ink, as well as the ink jet type recording head.

### SUMMARY OF THE INVENTION

Accordingly, the invention has been finalized in order to solve at least some of the above-described problems and may be realized by the following aspects or examples.

The invention has been finalized in order to solve at least some of the above-described problems and may be realized by the following aspects or examples.

According to an aspect of the invention, there is provided a method of manufacturing an actuator apparatus. The method includes laminating a lower electrode, a piezoelectric material layer, and an upper electrode on one surface of a base plate, simultaneously etching the upper electrode and the piezoelectric material layer to form a piezoelectric element, forming, on the base plate, a test pattern that is electrically discontinuous with the electrodes of the piezoelectric element and has the same layer as the lower electrode, the test pattern having the lower electrode with the upper electrode and the piezoelectric material layer removed by etching, and measuring electric resistance of the lower electrode of the test pattern to acquire an etch amount of the lower electrode when the piezoelectric element is formed.

The above and other features and objects of the invention will become apparent from the following description with reference to the accompanying drawings.

### BRIEF DESCRIPTION OF THE DRAWINGS

For better understanding of the invention and its advantages, reference will be made in the following description and the accompanying drawings.

FIG. 1 is an exploded perspective view showing the schematic configuration of a recording head according to a first embodiment of the invention.

FIG. 2 is a plan view of the recording head according to the first embodiment.

FIG. 3 is a sectional view of the recording head according to the first embodiment.

FIG. 4 is a sectional view showing a method of manufacturing a recording head according to the first embodiment.

FIG. 5 is a sectional view showing the method of manufacturing a recording head according to the first embodiment.

FIG. 6 is a plan view showing the method of manufacturing a recording head according to the first embodiment.

FIG. 7 is a plan view with essential parts enlarged showing the method of manufacturing a recording head according to the first embodiment.

FIG. 8 is a sectional view showing the method of manufacturing a recording head according to the first embodiment.

FIG. 9 is a plan view with essential parts enlarged showing the method of manufacturing a recording head according to the first embodiment.

FIG. 10 is a sectional view showing the method of manufacturing a recording head according to the first embodiment.

FIG. 11 is a sectional view showing the method of manufacturing a recording head according to the first embodiment.

FIG. 12 is a sectional view showing the method of manufacturing a recording head according to the first embodiment.

FIG. 13 is a plan view with essential parts enlarged showing a recording head according to another example of the first embodiment.

FIG. 14 is a sectional view of a recording head according to another example of the first embodiment.

FIG. 15 is a plan view with essential parts enlarged showing a recording head according to the second embodiment.

FIG. 16 is a sectional view of the recording head according to the second embodiment.

FIG. 17 is a sectional view of the recording head according to the second embodiment.

FIG. 18 is a schematic perspective view of a recording apparatus according to an embodiment of the invention.

### DETAILED DESCRIPTION OF THE PREFERRED EMBODIMENTS

At least the following will become apparent from the description herein and the accompanying drawings.

An aspect of the invention provides a method of manufacturing an actuator apparatus, the method including laminating a lower electrode, a piezoelectric material layer, and an upper electrode on one surface of a base plate, simultaneously etching the upper electrode and the piezoelectric material layer to form a piezoelectric element, forming, on the base plate, a test pattern that is electrically discontinuous with the electrodes of the piezoelectric element and has the same layer as the lower electrode, the test pattern having the lower electrode with the upper electrode and the piezoelectric material layer removed by etching, and measuring electric resistance of the lower electrode of the test pattern to acquire the etch amount of the lower electrode when the piezoelectric element is formed.

With this aspect, if electric resistance of the lower electrode of the test pattern is measured, the overetch amount of the lower electrode of the piezoelectric element when the upper electrode and the piezoelectric material layer are removed by etching can be acquired. Therefore, the displacement characteristic of the piezoelectric element due to the etch amount of the lower electrode of the piezoelectric element can be grasped, and the actuator apparatuses can be classified into ranks on the basis of the displacement characteristic of the piezoelectric element. As a result, a plurality of actuator apparatuses with uniform displacement characteristics of the piezoelectric elements can be obtained.

The lower electrode of the test pattern may be formed to have a cross shape, a current may flow in a pair of adjacent terminals of the lower electrode, and a potential difference between other terminals may be measured to measure electric resistance. With this configuration, only electric resistance of a cross intersection region of the test pattern can be measured. Therefore, a measurement error in electric resistance due to influences by other regions can be reduced, and as a result, measurement can be performed with high accuracy.

A plurality of piezoelectric elements may be arranged in parallel on the base plate, and test patterns may be formed at both end portions in the arrangement direction of the piezoelectric elements. With this configuration, a gradient of the overetch amount of the lower electrode in the arrangement direction of the piezoelectric elements can be grasped, and as a result, a gradient of the displacement characteristic in the arrangement direction of the piezoelectric elements can be grasped.

In the measuring of the etch amount of the lower electrode, electric resistance of the lower electrode may be measured in a first state, in which the test pattern is electrically discontinuous with the electrodes of the piezoelectric element and has the same layer as the lower electrode, and the piezoelectric material layer and the upper electrode are formed, and electric resistance may be measured in a second state, in which the test pattern has the lower electrode with the upper electrode and the piezoelectric material layer are etched simultaneously with the piezoelectric element, and the etch amount of the lower electrode may be acquired on the basis of electric resistance in the first state and electric resistance in the second state. With this configuration, electric resistance of the lower electrode of the test pattern in the first state and electric resistance of the lower electrode of the test pattern in the second state are measured and compared with each other. As a result, the overetch amount of the lower electrode of the piezoelectric element can be grasped with high accuracy.

The test pattern in the first state and the test pattern in the second state may be formed simultaneously with the piezoelectric element. With this configuration, it is possible to reliably prevent the lower electrode from being damaged when a probe is brought into contact with the lower electrode before the piezoelectric material layer and the upper electrode, and to prevent a foreign substance from occurring due to separation of the piezoelectric material layer and the upper electrode when the piezoelectric material layer and the upper electrode are formed in a subsequent step.

The etch amount acquired in the acquiring of the etch amount of the lower electrode may be fed back to control an etch amount of the upper electrode and the piezoelectric material layer. With this configuration, the acquired etch amount is fed back to control the etch amount of the upper electrode and the piezoelectric material layer. Therefore, the overetch amount of the lower electrode is made uniform, and as a result, an actuator apparatus having piezoelectric elements with uniform displacement characteristic can be formed.

Another aspect of the invention provides a method of manufacturing a liquid jet head, the method including forming the actuator apparatus on one surface of a flow channel forming plate, in which a pressure generation chamber is provided to communicate with a nozzle opening jetting a liquid.

With this aspect, the liquid jet characteristics of the liquid jet heads can be made uniform. Therefore, when a plurality of liquid jet heads are combined to form a head unit, the liquid jet characteristics can be made uniform, and as a result, printing can be performed with high accuracy and high quality.

Yet another aspect of the invention provides a liquid jet apparatus including the above-described liquid jet head. With this respect, the liquid jet characteristics can be made uniform, and as a result, a liquid jet apparatus that can perform printing with high accuracy and high quality can be realized.

Hereinafter, preferred embodiments of the invention will be described with reference to the drawings. The following embodiments are described as examples of the invention, and all the parts to be described below are not always essential parts.

### Best Embodiments

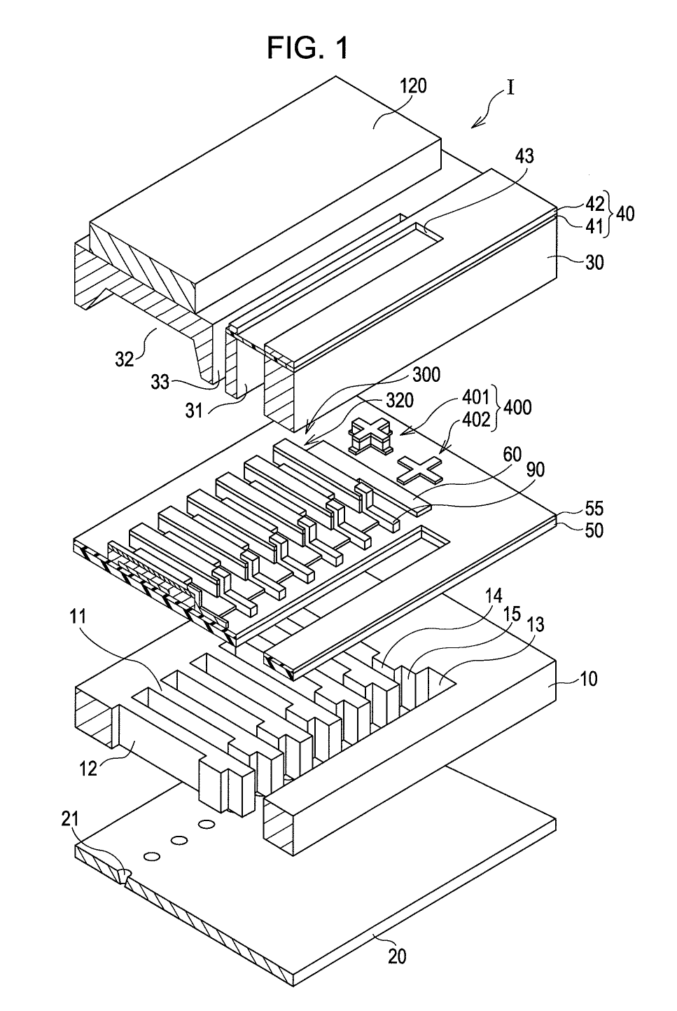

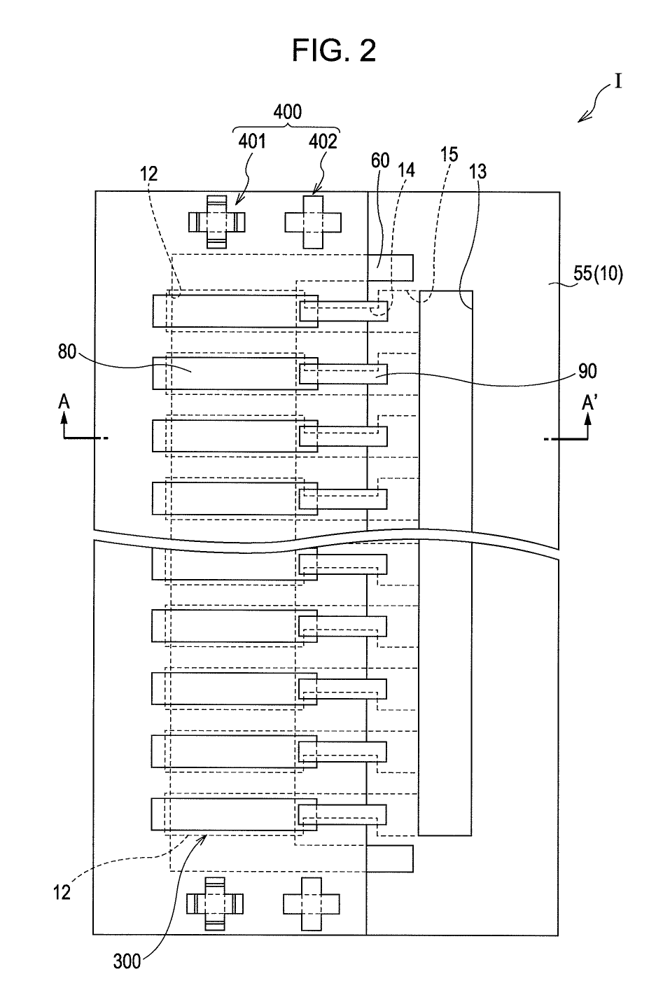

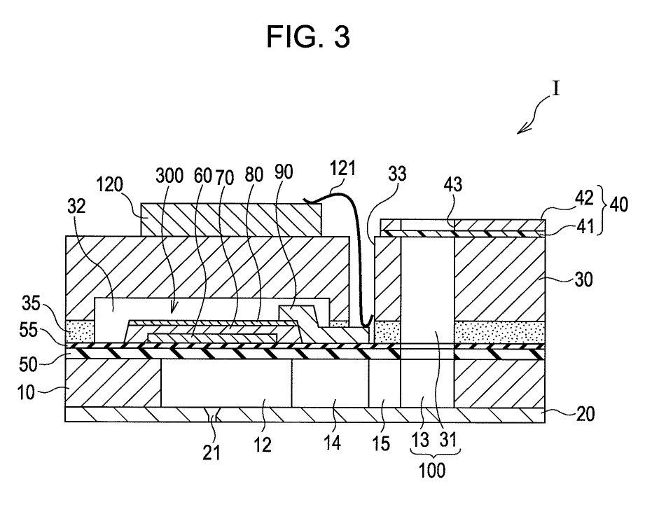

FIG. 1 is an exploded perspective view showing the schematic configuration of an ink jet type recording head that is an example of a liquid jet head according to the first embodiment of the invention. FIG. 2 is a plan view of a flow channel forming plate. FIG. 3 is a sectional view taken along the line A-A′ of FIG. 2.

As shown in the drawings, in this embodiment, a flow channel forming plate 10 is made of a silicon monocrystal plate, and an elastic film 50 made of silicon dioxide is formed on one surface of the flow channel forming plate 10.

The flow channel forming plate 10 is provided with a plurality of pressure generation chambers 12 arranged in parallel in a width direction thereof. A communicating portion 13 is formed in a region outside the flow channel forming plate 10 in a longitudinal direction of each pressure generation chamber 12, and the communicating portion 13 and each of the pressure generation chambers 12 communicate with each other through an ink supply channel 14 and a communicating channel 15, which are provided for each pressure generation chamber 12. The communicating portion 13 communicate with a reservoir portion 31 of a protective plate that will be described below, and forms a part of a reservoir serving as a common ink chamber of the pressure generation chambers 12. Each of the ink supply channels 14 is formed to have a width smaller than the corresponding pressure generation chamber 12, and maintains flow channel resistance of ink flowing into the pressure generation chamber 12 from the communicating portion 13. In this embodiment, the ink supply channel 14 is formed by narrowing the width of the flow channel on one side, but the ink supply channel may be formed by narrowing the width of the flow channel on both sides. Alternatively, the ink supply channel may be narrowed in a thickness direction, instead of being formed by narrowing the width of the flow channel.

A nozzle plate 20 is fixed onto an opening surface side of the flow channel forming plate 10 by an adhesive, a thermally welding film, or the like. The nozzle plate 20 is provided with nozzle openings 21, each of the nozzle openings 21 communicating with near an end portion of the corresponding pressure generation chamber 12 opposite to the corresponding ink supply channel 14. The nozzle plate 20 is made of, for example, glass ceramics, a silicon monocrystal plate, stainless steel, or the like.

On a side opposite to the opening surface of the flow channel forming plate 10, as described above, the elastic film 50 is formed. An insulator film 55 is formed on the elastic film 50. A lower electrode film 60, a piezoelectric material layer 70, and an upper electrode film 80 are laminated on the insulator film 55 by a process described below to constitute piezoelectric elements 300. Each of the piezoelectric elements 300 includes a portion having the lower electrode film 60, the piezoelectric material layer 70, and the upper electrode film 80. In general, one electrode of the piezoelectric elements 300 serves as a common electrode, and the other electrode and the piezoelectric material layer 70 are patterned for each pressure generation chamber 12. A portion which includes the patterned one electrode and the piezoelectric material layer 70, and at which piezoelectric strain occurs when a voltage is applied to both electrodes is referred to as an active piezoelectric portion. In this embodiment, the lower electrode film 60 forms the common electrode of the piezoelectric elements 300, and the upper electrode film 80 forms individual electrodes of the piezoelectric elements 300. This configuration may be reversed depending on the specific arrangement of the driving circuit or wiring.

As shown in FIGS. 2 and 3, in this embodiment, an end portion (length) in a longitudinal direction of the active piezoelectric portion 320 serving as a substantial driving portion of each piezoelectric element 300 is defined by providing an end portion of the lower electrode film 60 in the longitudinal direction of the corresponding pressure generation chamber 12 (an end portion in a longitudinal direction of the piezoelectric element 300) within a region opposite to the pressure generation chamber 12. An end portion (width) in a lateral direction of the active piezoelectric portion 320 is defined by providing an end portion of the upper electrode film 80 in a lateral direction of the pressure generation chamber 12 (an end portion in a lateral direction of the piezoelectric element 300) within a region opposite the pressure generation chamber 12. That is, the active piezoelectric portion 320 is provided only in a region opposite the corresponding pressure generation chamber 12 by the patterned lower electrode film 60 and upper electrode film 80. In this embodiment, as shown in FIG. 3, the piezoelectric material layer 70 and the upper electrode film 80 are patterned such that the upper electrode film 80 has a narrower width, and have slope side surfaces.

Each piezoelectric element 300 and a vibrating plate where displacement occurs when the piezoelectric element 300 is driven are collectively called an actuator apparatus. In the above-described example, the elastic film 50, the insulator film 55, and the lower electrode film 60 serve as a vibrating plate, but the invention is not limited thereto. For example, only the lower electrode film 60 may serve as a vibrating plate, while the elastic film 50 and the insulator film 55 may not be provided. Alternatively, the piezoelectric element 300 itself may substantially serve as a vibrating plate.

The piezoelectric material layer 70 is made of a piezoelectric material having an electromechanical conversion function provided on the lower electrode film 60. The piezoelectric material layer 70 is preferably a crystal film having a perovskite structure, for example, a ferroelectric material, such as lead zirconate titanate (PZT) or the like, or a mixture of a ferroelectric material and a metal oxide, such as niobium oxide, nickel oxide, or magnesium oxide. Specifically, lead titanate (PbTiO₃), lead zirconate titanate (Pb(Zr,Ti)O₃), lead zirconate (PbZrO₃), lead lanthanum titanate ((Pb,La),TiO₃), lead lanthanum zirconate titanate ((Pb,La)(Zr,Ti)O₃), or lead zirconate titanate magnesium niobate (Pb(Zr,Ti)(Mg,Nb)O₃) may be used. The piezoelectric material layer 70 is formed to have such a thickness as to suppress occurrence of a crack during the manufacturing process and to have a sufficient displacement characteristic. For example, in this embodiment, the piezoelectric material layer 70 is formed to have a thickness of about 1 to 2 μm.

A lead electrode 90 made of, for example, gold (Au) or the like is connected to each upper electrode film 80 serving as the individual electrode of each piezoelectric element 300. The lead electrode 90 is led from near an end portion on the ink supply channel 14 side and extends onto the insulator film 55.

A test pattern 400 is provided on the flow channel forming plate 10 so as to measure an overetch amount of the lower electrode film 60 when the piezoelectric elements 300 are formed by etching. The test pattern 400 will be described below in detail.

A protective plate 30 that has a reservoir portion 31 constituting at least a part of a reservoir 100 is bonded onto the flow channel forming plate 10, on which the piezoelectric elements 300 are formed, that is, on the lower electrode film 60, the insulator film 55, and the lead electrodes 90 by an adhesive 35. In this embodiment, the reservoir portion 31 passes through the protective plate 30 in its thickness direction and extends along the width direction of each pressure generation chamber 12. As described above, the reservoir portion 31 communicates with the communicating portion 13 of the flow channel forming plate 10 and constitutes the reservoir 100 serving as a common ink chamber of the pressure generation chambers 12. The communicating portion 13 of the flow channel forming plate 10 may be divided into compartments which correspond to the pressure generation chambers 12, such that only the reservoir portion 31 may serve as the reservoir. Alternatively, only the pressure generation chambers 12 may be provided in the flow channel forming plate 10, and the ink supply channels 14 which individually communicate with the pressure generation chambers 12 may be provided in a member (for example, the elastic film 50, the insulator film 55, or the like) interposed between the flow channel forming plate 10 and the protective plate 30.

A piezoelectric element holding portion 32 is provided in a region of the protective plate 30 opposite the piezoelectric elements 300. The piezoelectric element holding portion 32 has a space sufficient so as not to interfere with the operation of the piezoelectric elements 300. The piezoelectric element holding portion 32 may be sealed or unsealed insofar as it has a space sufficient so as not to interfere with the operation of the piezoelectric elements 300.

The protective plate 30 is preferably made of a material having the substantially same thermal expansion coefficient as the flow channel forming plate 10. For example, glass, a ceramic material, or the like may be used. In this embodiment, the protective plate 30 is made of a silicon monocrystal plate, which is the same material as the flow channel forming plate 10.

The protective plate 30 is provided with a through hole 33 that passes through the protective plate 30 in its thickness direction. The end portions of the lead electrodes 90 individually led from the piezoelectric element 300 are exposed through the through hole 33.

A driving circuit 120 is fixed onto the protective plate 30 so as to drive the piezoelectric elements 300 arranged in parallel. The driving circuit 120 may be, for example, a circuit board, a semiconductor integrated circuit (IC), or the like. The driving circuit 120 and the lead electrodes 90 are electrically connected to each other through connection wires 121 made of conductive wirings, such as bonding wires.

A compliance plate 40 having a seal film 41 and a fixed plate 42 is bonded onto the protective plate 30. The seal film 41 is made of a flexible material having low rigidity. The seal film 41 seals one surface of the reservoir portion 31. The fixed plate 42 is made of a comparatively hard material. A region of the fixed plate 42 opposite the reservoir 100 is completely removed in a thickness direction of the fixed plate 42 to form an opening 43, and thus one surface of the reservoir 100 is sealed only by the flexible seal film 41.

In such an ink jet type recording head of this embodiment, ink is supplied from an ink introduction port connected to an external ink supply unit (not shown), and filled from the reservoir 100 to the nozzle openings 21. Voltage is applied between the lower electrode film 60 and the upper electrode films 80 corresponding to the pressure generation chambers 12 in accordance with a recording signal from the driving circuit 120, and the elastic film 50, the insulator film 55, the lower electrode film 60, and the piezoelectric material layer 70 are deformed in a deflection manner. Accordingly, pressure in the pressure generation chambers 12 increases, and thus ink droplets are ejected from the nozzle openings 21.

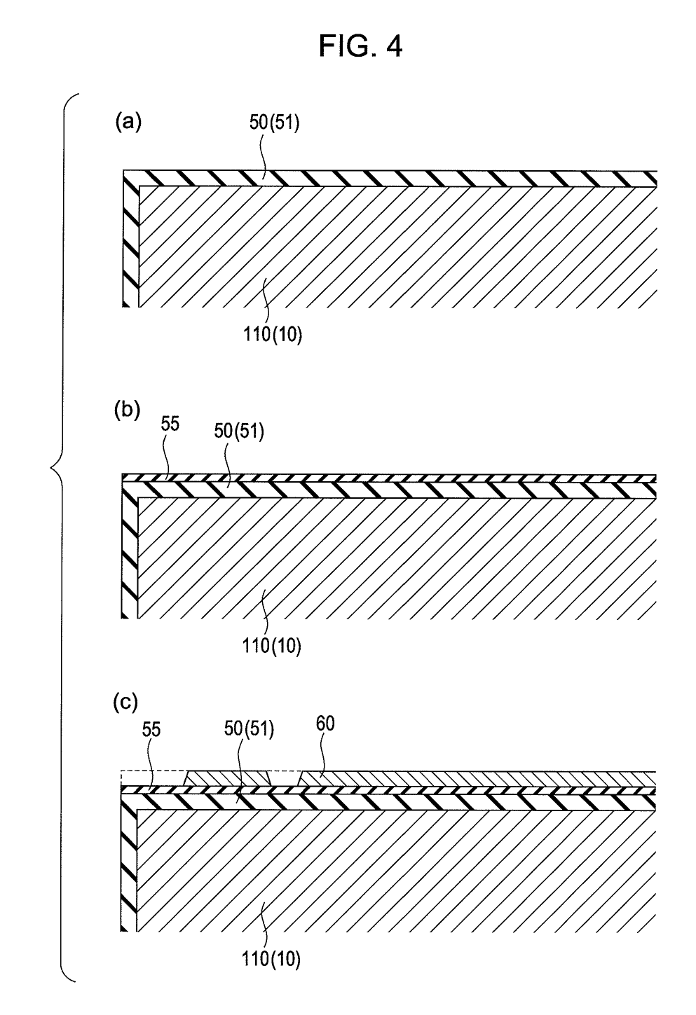

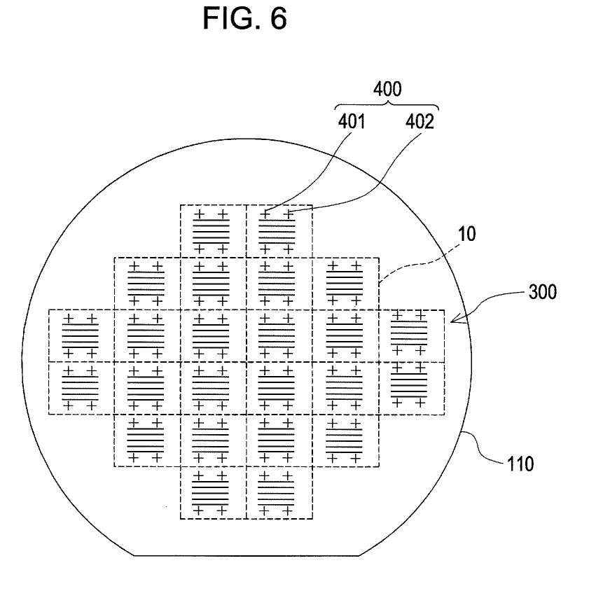

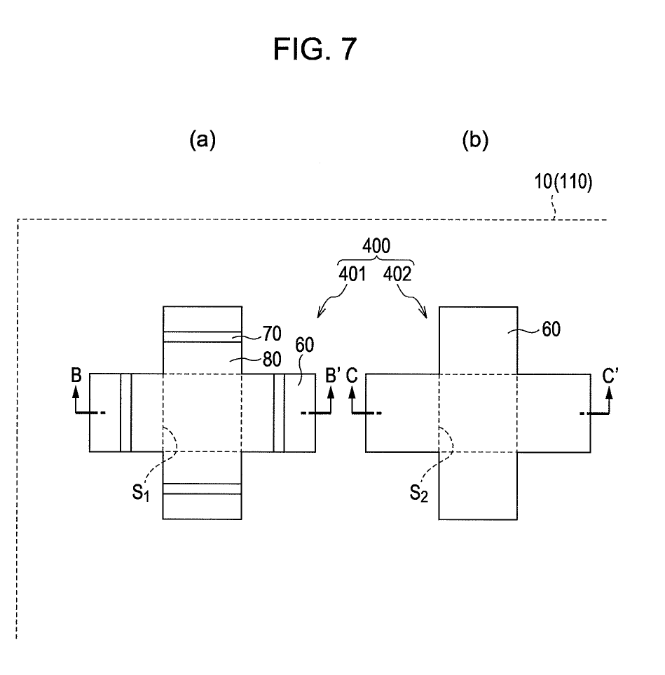

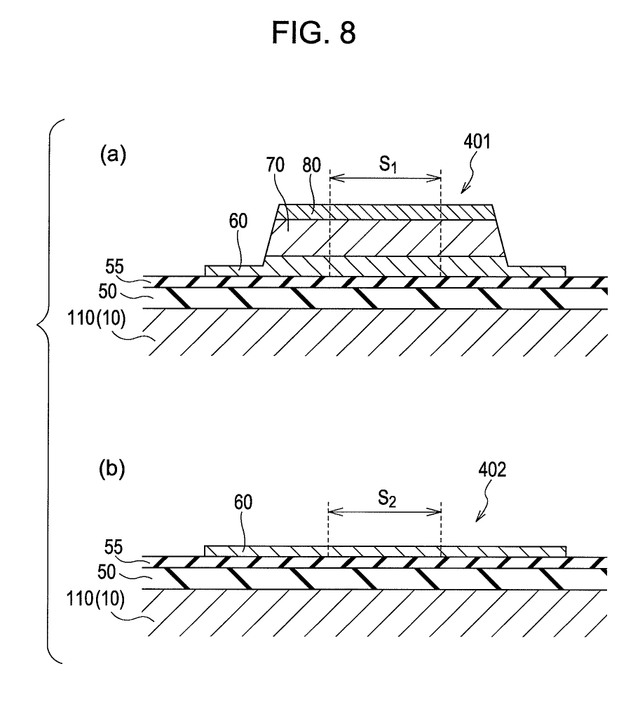

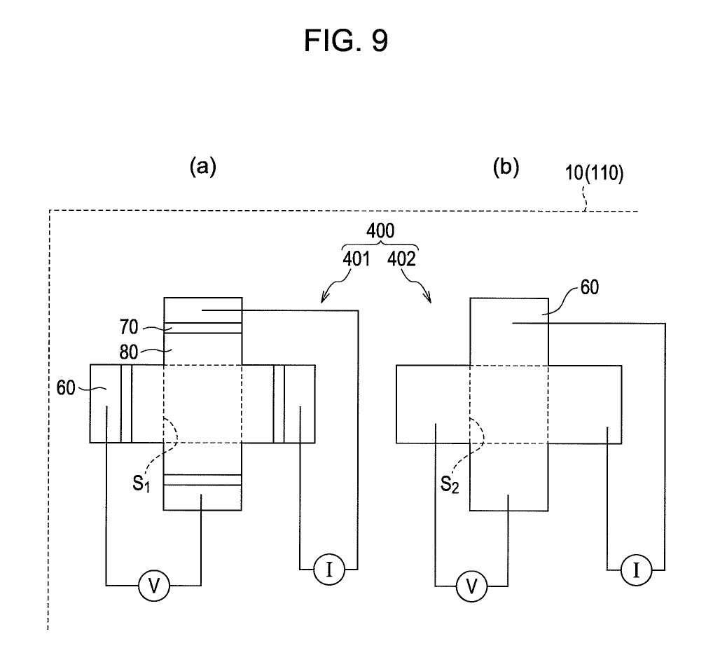

A method of manufacturing an ink jet type recording head will be described with reference to FIGS. 4 to 12. FIGS. 4, 5, and 10 to 12 are sectional views in the lateral direction of the pressure generation chamber. FIG. 6 is a plan view of a wafer for flow channel forming plates. FIG. 7 is a plan view with essential parts enlarged of FIG. 6. FIG. 8 is a sectional view taken along the line B-B′ of FIG. 7 and a sectional view taken along the line C-C′ of FIG. 7. FIG. 9 is a plan view with essential parts enlarged of a wafer for flow channel forming plates.

As shown in FIG. 4(a), a silicon dioxide film 51 made of silicon dioxide (SiO₂) for forming the elastic film 50 is formed on a surface of a wafer 110 for flow channel forming plates, which is a silicon wafer having a plurality of flow channel forming plates 10 as a single body. Next, as shown in FIG. 4(b), the insulator film 55 made of zirconium oxide is formed on the elastic film 50 (the silicon dioxide film 51).

Next, as shown in FIG. 4(c), for example, platinum and iridium are laminated on the insulator film 55 to form the lower electrode film 60, and then the lower electrode film 60 is patterned in a predetermined shape. The lower electrode film 60 is not limited to a laminate of platinum (Pt) and iridium (Ir), but the lower electrode film 60 may be made of an alloy of platinum (Pt) and iridium (Ir). Alternatively, the lower electrode film 60 may be a single layer of either platinum (Pt) or iridium (Ir). A metal other than platinum (Pt) and iridium (Ir) or a metal oxide may be used.

The lower electrode film 60 is formed over regions of the wafer 110 for a flow channel forming plate where the pressure generation chambers 12 are provided, and an end portion thereof in the longitudinal direction of each pressure generation chamber 12 is removed. When the lower electrode film 60 is patterned, the lower electrode film 60 is formed in a region where the test pattern 400, which is used to measure the overetch amount of the lower electrode film 60 when the upper electrode film 80 and the piezoelectric material layer 70 are etched to form the piezoelectric elements 300 in a subsequent step, is formed. The test pattern 400 is preferably provided so as to be electrically discontinuous with the lower electrode film 60 serving as the common electrode of the piezoelectric elements 300. In this embodiment, the test patterns 400 are provided at both end portions in the arrangement direction of the piezoelectric elements 300 in a region of the wafer 110 for flow channel forming plates where each flow channel forming plate 10 is provided.

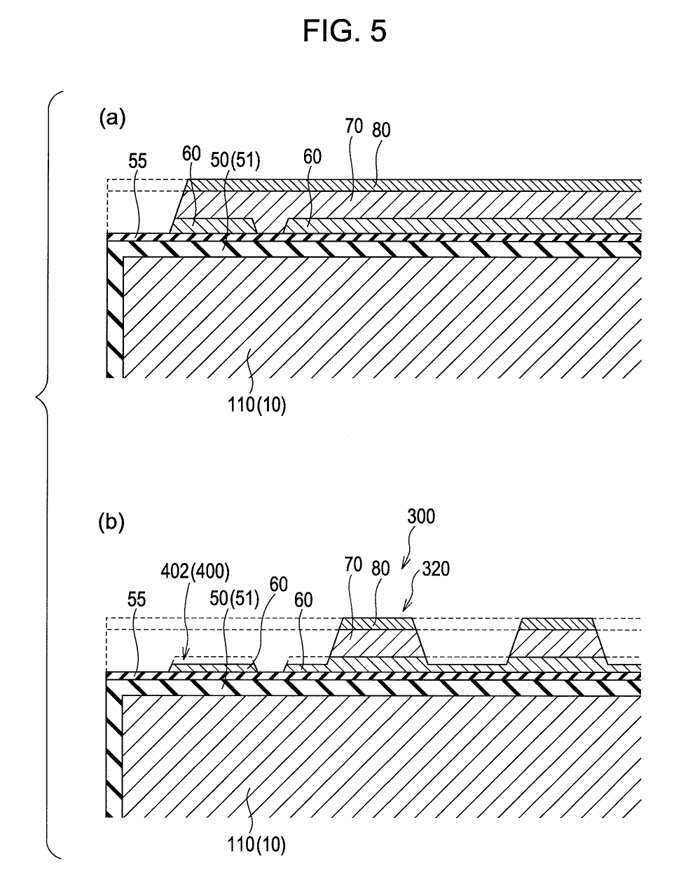

Next, as shown in FIG. 5(a), the piezoelectric material layer 70 made of lead zirconate titanate (PZT) or the like and the upper electrode film 80 made of iridium are formed on the entire surface of the wafer 110 for flow channel forming plates. In this embodiment, the piezoelectric material layer 70 is formed by a so-called sol-gel process which forms the piezoelectric material layer 70 made of a metal oxide by applying and drying a so-called sol, in which a metallo-organic compound is dissolved and dispersed in a solvent, so as to obtain a gel, and firing the gel at high temperature. The forming process of the piezoelectric material layer 70 is not particularly limited. For example, a MOD (Metal-Organic Decomposition) process, a sputtering process, a laser ablation process, a PVD (Physical Vapor Deposition) process, or the like may be used.

Incidentally, when a plurality of different material layers are laminated as the lower electrode film 60 by a sputtering process or the like, the lower electrode film 60 is also heated during heat treatment of the piezoelectric material layer 70. Accordingly, a plurality of material layers constituting the lower electrode film 60 may be partially oxidized or alloyed, and become complex layers.

Next, as shown in FIG. 5(b), the upper electrode film 80 and the piezoelectric material layer 70 are etched simultaneously to form the piezoelectric elements 300 in the regions corresponding to the pressure generation chambers 12. The upper electrode film 80 and the piezoelectric material layer 70 are etched by, for example, dry etching, such as reactive ion etching or ion milling.

In this embodiment, as shown in FIG. 5, when the piezoelectric elements 300 are etched, the piezoelectric material layer 70 and the upper electrode film 80 are etched simultaneously to form the test pattern 400. The test patterns 400 are provided at both end portions in the arrangement direction of the piezoelectric elements 300 in the region where each flow channel forming plate 10 is provided.

As the test pattern 400, in this embodiment, as shown in FIG. 7, a first test pattern 401 and a second test pattern 402 are formed. In this embodiment, the first test pattern 401 and the second test pattern 402 are formed to have a cross shape in plan view. That is, the first test pattern 401 and the second test pattern 402 constituting the test pattern 400 have a Van der Pol structure.

Specifically, as shown in FIG. 8(a), the first test pattern 401 includes the lower electrode film 60 which is the same layer as the lower electrode film 60 and electrically discontinuous with the lower electrode film 60 serving as the common electrode of the piezoelectric elements 300, the piezoelectric material layer 70 which is the same layer as the piezoelectric material layer 70 of each piezoelectric element 300 and discontinuous with the piezoelectric element 300, and the upper electrode film 80 which is the same layer as the upper electrode film 80 of each piezoelectric element 300 and electrically discontinuous with the upper electrode film 80 of the piezoelectric element 300. That is, the first test pattern 401 is in a first state in which the first test pattern 401 is electrically discontinuous with the lower electrode film 60 serving as the common electrode of the piezoelectric elements 300 and has the same layer as the lower electrode film 60, and the piezoelectric material layer 70 and the upper electrode film 80 are formed.

End portions of the lower electrode film 60 of the first test pattern 401 are exposed so as not to be covered with the piezoelectric material layer 70 and the upper electrode film 80 to form terminal portions.

As shown in FIG. 8(b), the second test pattern 402 has only the lower electrode film 60 which is the same layer as the lower electrode film 60, is electrically discontinuous with the lower electrode film 60 of the piezoelectric element 300, and has a cross shape in plan view. That is, the piezoelectric material layer 70 and the upper electrode film 80 on the second test pattern 402 are removed by etching simultaneously when the piezoelectric elements 300 are etched. The second test pattern 402 is in a second state in which the second test pattern 402 is electrically discontinuous with the lower electrode film 60 serving as the common electrode of the piezoelectric elements 300 and has the same layer as the lower electrode film 60, and the upper electrode film 80 and the piezoelectric material layer 70 on the lower electrode film 60 are removed when the piezoelectric elements 300 are patterned.

The upper electrode film 80 and the piezoelectric material layer 70 are etched until the surface of the lower electrode film 60 between adjacent piezoelectric elements 300 and the surface of the lower electrode film 60 of the test pattern 401 are exposed. Accordingly, the lower electrode film 60 between adjacent piezoelectric elements 300 and the lower electrode film 60 of the second test pattern 402 are partially overetched in the thickness direction. The overetch amount of the lower electrode film 60 of the second test pattern 402 becomes equal to the overetch amount of the lower electrode film 60 between adjacent piezoelectric elements 300.

That is, the overetch amount of the lower electrode film 60 of the second test pattern 402 in the second state becomes equal to the overetch amount of the lower electrode film 60 between adjacent piezoelectric elements 300. In other words, a cross intersection region S₂ of the lower electrode film 60 of the second test pattern 402 has the same etch amount as the overetch amount of the lower electrode film 60 serving as the common electrode of the piezoelectric elements 300.

Meanwhile, in a cross intersection region S₁ of the lower electrode film 60 of the first test pattern 401 in the first state, the piezoelectric material layer 70 and the upper electrode film 80 are formed. For this reason, the region S₁ is not overetched. The end portions of the lower electrode film 60 of the first test pattern 401 are exposed with the upper electrode film 80 and the piezoelectric material layer 70 removed. Accordingly, the end portions of the lower electrode film 60 of the first test pattern 401 are also overetched, but in a step described below in detail, there is little influence when electric resistance of the lower electrode film 60 of the first test pattern 401 is measured.

In this embodiment, as described above, the piezoelectric material layer 70 and the upper electrode film 80 are not formed between adjacent piezoelectric elements 300, and the surface of the lower electrode film 60 is exposed. The reason is as follows. In this embodiment, the lower electrode film 60 forms the common electrode of a plurality of piezoelectric elements 300, and the upper electrode film 80 forms the individual electrodes of the piezoelectric elements 300. For this reason, the upper electrode film 80 between adjacent piezoelectric elements 300 is removed such that the corresponding upper electrode film 80 serves as the individual electrode. In addition, the piezoelectric material layer 70 between adjacent piezoelectric elements 300 is removed such that the piezoelectric material layer 70 is not formed in an extra region as the vibrating plate of each piezoelectric element 300. As a result, the displacement characteristic of the vibrating plate is improved.

After the piezoelectric elements 300 and the test pattern 400 are formed, electric resistance of the lower electrode films 60 of the test pattern 400 is measured. Specifically, as shown in FIG. 9, a current flows in two adjacent end portions of the lower electrode film 60 of the first test pattern 401 in the first state, and a potential difference between other two end portions of the lower electrode film 60, thereby measuring electric resistance of the lower electrode film 60. That is, sheet resistance Rs is calculated on the basis the measured current (I) and voltage (V: potential difference) by a calculation formula Rs=π/(ln 2)×(V/I). Here, electric resistance is sheet resistance.

With respect to the lower electrode film 60 of the second test pattern 402 in the second state, electric resistance is measured in the same manner as the first test pattern 401.

Electric resistance of the lower electrode films 60 of the test pattern 400 may be measured by bringing a probe into direct contact with the exposed end portions of each lower electrode film 60 of the test pattern 400.

Such electric resistance measurement is generally called a four-terminal method (four-probe method) and useful for measuring electric resistance of the thin lower electrode film 60, which is used in the piezoelectric element 300. Like this embodiment, if the four end portions of the lower electrode film 60 of the test pattern 400 having a cross shape (Van der Pol structure) are measured by the four-terminal method (four-probe method), electric resistance of the cross intersection regions S₁ and S₂ of the lower electrode films 60 of the test pattern 400 can be measured.

Accordingly, electric resistance of the nonoveretched intersection region S₁ of the lower electrode film 60 of the first test pattern 401 in the first state and electric resistance of the overetched intersection region S₂ of the lower electrode film 60 of the second test pattern 402 in the second state can be measured, and thus the overetch amount of the lower electrode film 60 of the second test pattern 402 in the second state can be acquired. Electric resistance of the lower electrode film 60 is inversely proportional to the section area of the lower electrode film 60. Therefore, the lower electrode film 60 of the second test pattern 402 has a thickness smaller than the lower electrode film 60 of the first test pattern 401, and electric resistance of the second test pattern 402 becomes larger than electric resistance of the first test pattern 401. If a difference between electric resistance of the first test pattern 401 and electric resistance of the second test pattern 402 is large, it can be seen that the overetch amount of the second test pattern 402 is large (the lower electrode film 60 has a small thickness). If the difference in electric resistance is small, it can be seen that the overetch amount of the lower electrode film 60 of the second test pattern 402 is small (the lower electrode film 60 has a large thickness).

If the test pattern 400 is formed to have a cross shape, that is, a Van der Pol structure in plan view, and electric resistance of the lower electrode films 60 of the test pattern 400 is measured by a four-terminal method, electric resistance of only the cross intersection regions S₁ and S₂ can be measured. Therefore, like the first test pattern 401, even if the end portions of the lower electrode film 60 are overetched so as to be exposed, there is no influence.

As described above, if the overetch amount of the lower electrode film 60 of the second test pattern 402 is acquired, the thickness of the lower electrode film 60 that is provided over the piezoelectric elements 300 arranged in parallel and constitutes a part of the vibrating plate can be grasped.

Incidentally, the displacement characteristic of the vibrating plate changes depending on the overetch amount of the lower electrode film 60 between adjacent piezoelectric elements 300, and the ink ejection characteristic changes. For example, if the overetch amount of the lower electrode film 60 is large, since the lower electrode film 60 (vibrating plate) has a small thickness, the displacement increases and the ink ejection amount increases. If the overetch amount of the lower electrode film 60 is small, since the lower electrode film 60 has a large thickness, the displacement decreases and the ink ejection amount decreases. The overetch amount of the lower electrode film 60 easily changes due to a change in environment, such as temperature or humidity, or a change in output power of the etching apparatus. For this reason, in order to manufacture a stable product, it is necessary to grasp the overetch amount of the lower electrode film 60.

Like the invention, if the etch amount of the lower electrode film 60 of the piezoelectric element 300 is acquired by the test pattern 400, the displacement of the piezoelectric element 300 can be evaluated on the basis of the etch amount of the lower electrode film 60, and ink jet type recording heads can be classified into ranks on the basis of the displacement of the piezoelectric element 300. If the etch amount of the lower electrode film 60 is acquired and the acquired etch amount is fed back to control the etch amount of the upper electrode film 80 and the piezoelectric material layer 70, ink jet type recording heads in which the etch amount of the lower electrode film 60 is made uniform can be formed. That is, if the etch amount of the lower electrode film 60 on the next wafer 110 for flow channel forming plates is controlled on the basis of the initially acquired etch amount of the lower electrode film 60 on the wafer 110 for flow channel forming plates, ink jet type recording heads in which the displacement characteristics of the piezoelectric element 300 are made uniform can be formed from a plurality of wafers 110 for flow channel forming plates.

Therefore, when a plurality of ink jet type recording heads are combined to manufacture an ink jet type recording head unit, the ink ejection characteristics (liquid jet characteristics) of the ink jet type recording heads can be made uniform, and as a result, printing can be performed by the ink jet type recording head unit with high accuracy and high quality.

Like this embodiment, if the test patterns 400 are provided at both end portions in the arrangement direction of the piezoelectric elements 300, and the overetch amount of the lower electrode film 60 at both end portions in the arrangement direction of the piezoelectric elements 300 are acquired, a gradient (tendency) of the overetch amount of the lower electrode film 60 in the arrangement direction of the piezoelectric elements 300 can be grasped. That is, even though the overetch amount of the lower electrode film 60 at both end portions in the arrangement direction of the piezoelectric elements 300 is within the tolerance, if the gradient of the overetch amount of the lower electrode film 60 in the arrangement direction of the piezoelectric element 300 is large, a variation in the ink ejection characteristic in the arrangement direction of the nozzle openings 21 occurs. Therefore, if the overetch amount of the lower electrode film 60 at both end portions in the arrangement direction of the piezoelectric elements 300 and the gradient of the overetch amount of the lower electrode film 60 in the arrangement direction of the piezoelectric elements 300 are grasped, it is possible to determine whether or not the ink ejection characteristics of ink to be ejected from the nozzle openings 21 is within a desired range, and to determine a variation in the ink ejection characteristic in the arrangement direction of the nozzle openings 21.

Like this embodiment, if the test pattern 400 is provided in the region where each flow channel forming plate 10 is provided, a variation in the etch amount of the lower electrode film 60 within the plane of the wafer 110 for flow channel forming plates can be grasped. For this reason, the etch amount of the lower electrode film 60 within the plane of the next wafer 110 for flow channel forming plates can be controlled, and thus a plurality of ink jet type recording heads in which the displacement characteristics of the piezoelectric element 300 are made uniform can be manufactured from a plurality of wafers 110 for flow channel forming plates. Therefore, the etch amount of the lower electrode film 60 on a plurality of wafers 110 for flow channel forming plates can be made uniform, and the displacement of the piezoelectric elements 300 can be made uniform. For this reason, a plurality of ink jet type recording heads from a plurality of wafers 110 for flow channel forming plates can be combined to form a single head unit. As a result, yield can be improved and costs can be reduced. That is, after a plurality of ink jet type recording heads are manufactured, it is not necessary to classify the ink jet type recording heads into ranks on the basis of the displacement of the piezoelectric element 300.

In this embodiment, a pair of test patterns 400 are provided on both sides in the arrangement direction of the piezoelectric elements 300 in the region where each flow channel forming plate 10 is provided, but the invention is not particularly limited thereto. For example, a single test pattern 400 may be provided between two adjacent flow channel forming plates 10 in the arrangement direction of the piezoelectric elements 300, and the test pattern 400 may serve as a common test pattern 400 of the two flow channel forming plates 10. Alternatively, the average etch amount of a plurality of test patterns 400 in the region of the single wafer 110 for flow channel forming plates where each flow channel forming plate 10 is provided may be set as the etch amount of the lower electrode film 60 in the entire wafer 110 for flow channel forming plates.

The etch amount of the lower electrode film 60 may be controlled by changing the etching condition, such as etching time or output power of the etching apparatus. In particular, if the etching time is adjusted, the etch amount of the lower electrode film 60 can be easily and reliably controlled.

Incidentally, the test pattern 400 may be formed of a material or by a process different from the lower electrode film 60 of each piezoelectric element 300. The test pattern 400 is used to measure the overetch amount of the lower electrode film 60 when the upper electrode film 80 and the piezoelectric material layer 70 are etched in order to form the piezoelectric elements 300. Accordingly, in this instance, an error occurs between the etch amount of the lower electrode film 60 and the etch amount of the test pattern 400. In contrast, according to the invention, the overetch amount of the lower electrode film 60 can be measured by the test pattern 400 having the same layer as the lower electrode film 60 of the piezoelectric element 300 with high accuracy. Like this embodiment, if the test pattern 400 is formed simultaneously with the piezoelectric element 300 with the same configuration and by the same process as an adjacent piezoelectric element 300, the piezoelectric element 300 and the test pattern 400 can be formed under the same condition, and as a result, the overetch amount of the lower electrode film 60 can be measured with higher accuracy.

As described above, when a plurality of different material layers are laminated by a sputtering process as the lower electrode film 60, the lower electrode film 60 is also heated during heat treatment of the piezoelectric material layer 70. Accordingly, a plurality of material layers constituting the lower electrode film 60 may be partially oxidized or alloyed and become complex layers. For this reason, the lower electrode film 60 of the test pattern 400 is formed by the same process as the lower electrode film 60 of each piezoelectric element 300 which is actually driven (used for ink ejection). That is, similarly to the actual piezoelectric element 300, the lower electrode film 60 of the test pattern 400 is formed by forming the piezoelectric material layer 70 and the upper electrode film 80 on the lower electrode film 60 of the test pattern 400, and then partially removing the piezoelectric material layer 70 and the upper electrode film 80. Therefore, the test pattern 400 having the lower electrode film 60 formed under the same condition (complex layer) as the lower electrode film 60 of the piezoelectric element 300, which is actually driven, can be measured. As a result, a more accurate measurement result can be obtained, compared with a case in which a lower electrode for measurement formed under a condition different from the piezoelectric element 300, which is driven, is measured.

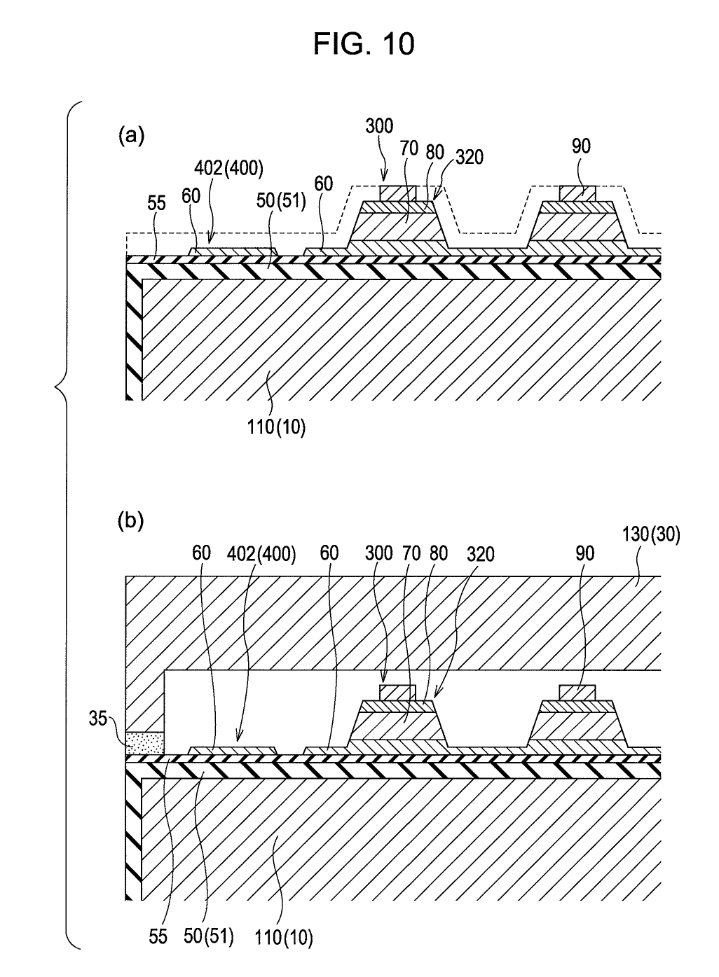

Next, as shown in FIG. 10(a), the lead electrode 90 made of gold (Au) is formed on the entire surface of the wafer 110 for flow channel forming plates and patterned for each piezoelectric element 300.

Next, as shown in FIG. 10(b), a wafer 130 for protective plates is bonded onto the wafer 110 for flow channel forming plates by an adhesive 35. The wafer 130 for protective plates has a plurality of protective plates 30 as a single body. The reservoir portion 31 and the piezoelectric element holding portion 32 are formed in the wafer 130 for protective plates in advance. If the wafer 130 for protective plates is bonded, rigidity of the wafer 110 for flow channel forming plates is significantly improved.

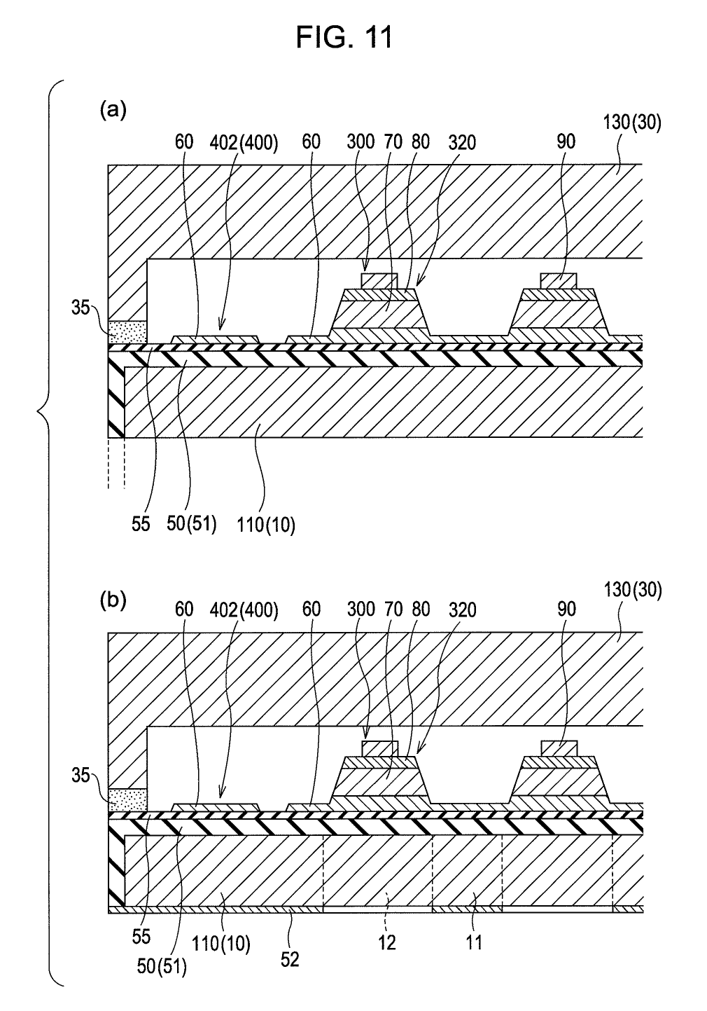

Next, as shown in FIG. 11(a), the wafer 110 for flow channel forming plates is thinned to have a predetermined thickness.

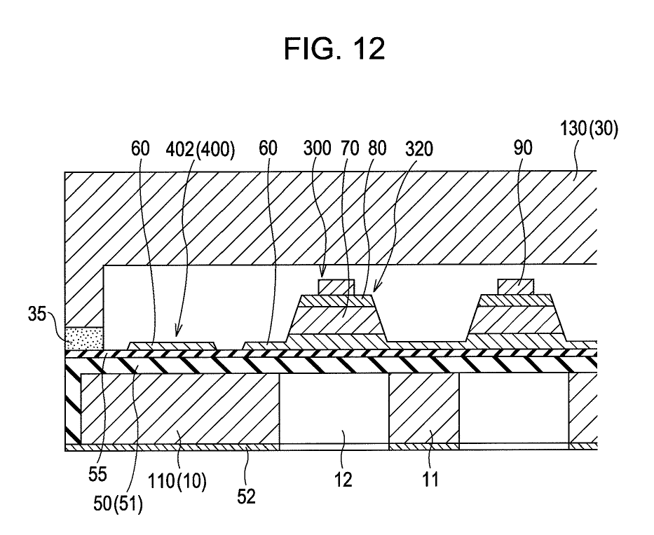

Next, as shown in FIG. 11(b), a mask 52 is newly formed on the wafer 110 for flow channel forming plates to pattern the wafer 110 for flow channel forming plates in a predetermined shape. Next, as shown in FIG. 12, anisotropic etching (wet etching) using an alkali solution, such as KOH or the like, is performed on the wafer 110 for flow channel forming plates through the mask 52. Thus, the pressure generation chambers 12 corresponding to the piezoelectric elements 300, the communicating portion 13, the ink supply channels 14, and the communicating channels 15 are formed.

Thereafter, the mask 52 on the surface of the wafer 110 for flow channel forming plates is removed, and unnecessary portions at outer edge portions of the wafer 110 for flow channel forming plates and the wafer 130 for protective plates are removed by cutting, such as dicing. The nozzle plate 20 having formed the nozzle openings 21 is bonded to a surface of the wafer 110 for flow channel forming plates opposite to the wafer 130 for protective plates, and the compliance plate 40 is bonded to the wafer 130 for protective plates. The wafer 110 for flow channel forming plates and the like are divided into the flow channel forming plates 10 and the like of a single chip size, as shown in FIG. 1. Thus, the ink jet type recording head of this embodiment is obtained.

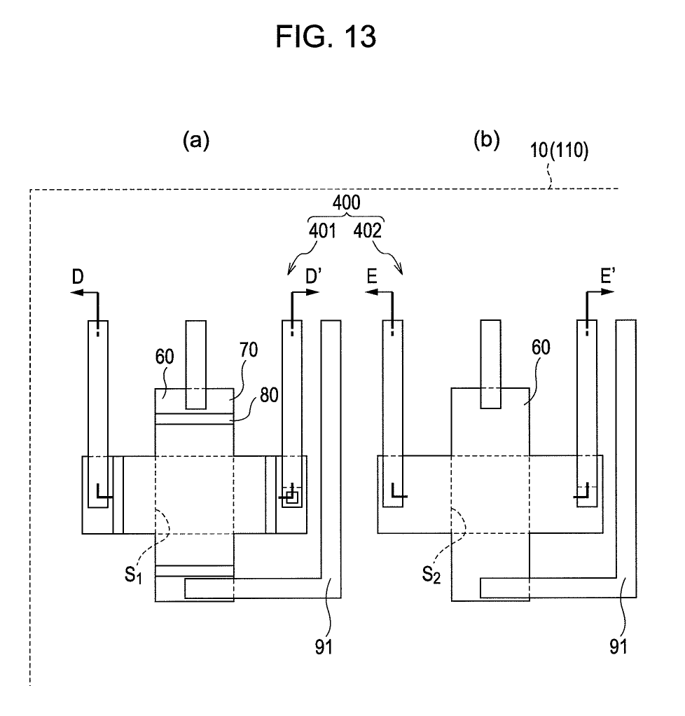

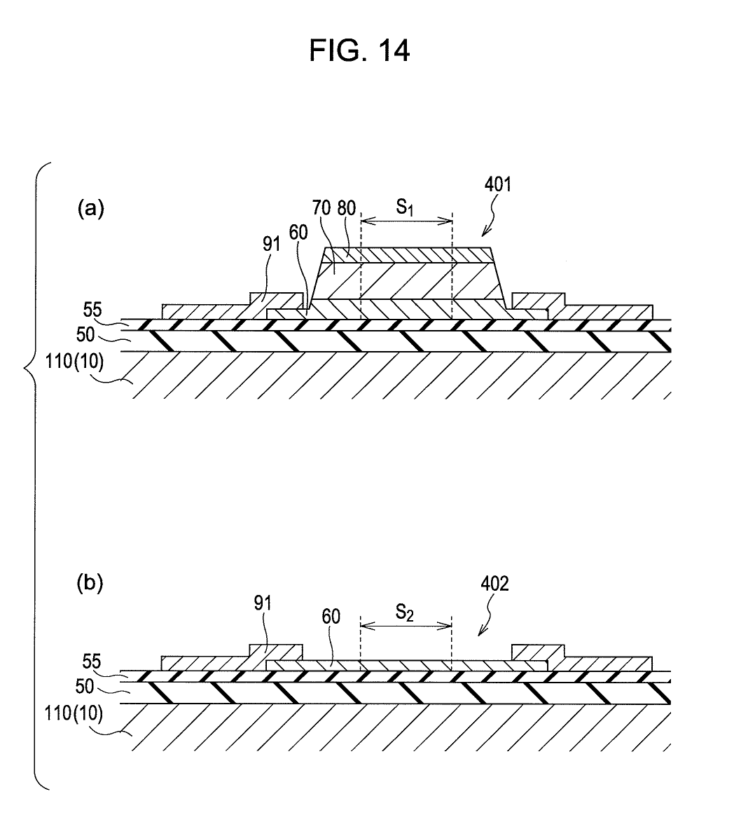

In this embodiment, electric resistance is measured by bringing the probe into direct contact with the end portions of each lower electrode film 60 of the test pattern 400, but the invention is not particularly limited thereto. Another example is shown in FIG. 13. FIG. 13 is a plan view with essential parts enlarged of the wafer for flow channel forming plates. FIG. 14 is a sectional view taken along the line D-D′ of FIG. 13 and a sectional view taken along the line E-E′ of FIG. 13.

As shown in the drawings, when the lead electrodes 90 that are lead wires individually led from the piezoelectric elements 300 are formed, test lead wires 91 that are individually led from the lower electrode films 60 of the test pattern 400 are formed. A probe is brought into contact with the test lead wires 91 to measure electric resistance of the lower electrode films 60 of the test pattern 400. In this case, measurement of electric resistance of the lower electrode films 60 of the test pattern 400 is not particularly limited insofar as it is performed after the lead electrodes 90 are formed. For example, electric resistance measurement may be performed after the wafer 130 for protective plates is bonded to the wafer 110 for flow channel forming plates, or after the wafer 110 for flow channel forming plates and the like are divided into chips. Even if electric resistance of the lower electrode films 60 of the test pattern 400 is measured through the test lead wires 91, only electric resistance of the cross intersection regions S₁ and S₂ of the test pattern 400 can be measured.

If electric resistance of the lower electrode films 60 of the test pattern 400 are measured after the lead electrodes 90 and the test lead wires 91 are formed, it is possible to prevent the lower electrode film 60 from being partially separated in a subsequent step (particularly, the step of forming the lead electrodes 90) due to damages when the probe is in contact with the lower electrode film 60, and to suppress occurrence of a foreign substance. The lower electrode film 60 of the test pattern 400 is etched by inverse sputter etching when the lead electrodes 90 are formed by sputtering. For this reason, if the electric resistance of the test pattern 400 is measured after the lead electrodes 90 are formed, the etch amount by inverse sputter etching when the lead electrodes 90 are formed can also be measured, and thus the final thickness of the lower electrode film 60 can be grasped. Of course, as shown in FIG. 7, even though no test lead wires 91 are provided in the test pattern 400, if electric resistance of the lower electrode film 60 of the test pattern 400 is measured after the lead electrodes 90 are patterned in a predetermined shape, the etch amount by inverse sputter etching when the lead electrodes 90 are formed can be measured, and thus the final thickness of the lower electrode film 60 can be grasped.

In FIGS. 12 and 13, the test lead wires 91 are provided in the test pattern 400, and the test lead wires 91 extend to the end portion of the flow channel forming plate 10, but the invention is not particularly limited thereto. For example, the test lead wires 91 may not be provided in the test pattern 400, and at least the lower electrode films 60 of the test pattern 400 may extend to the same positions as the test lead wires 91.

### Second Embodiment

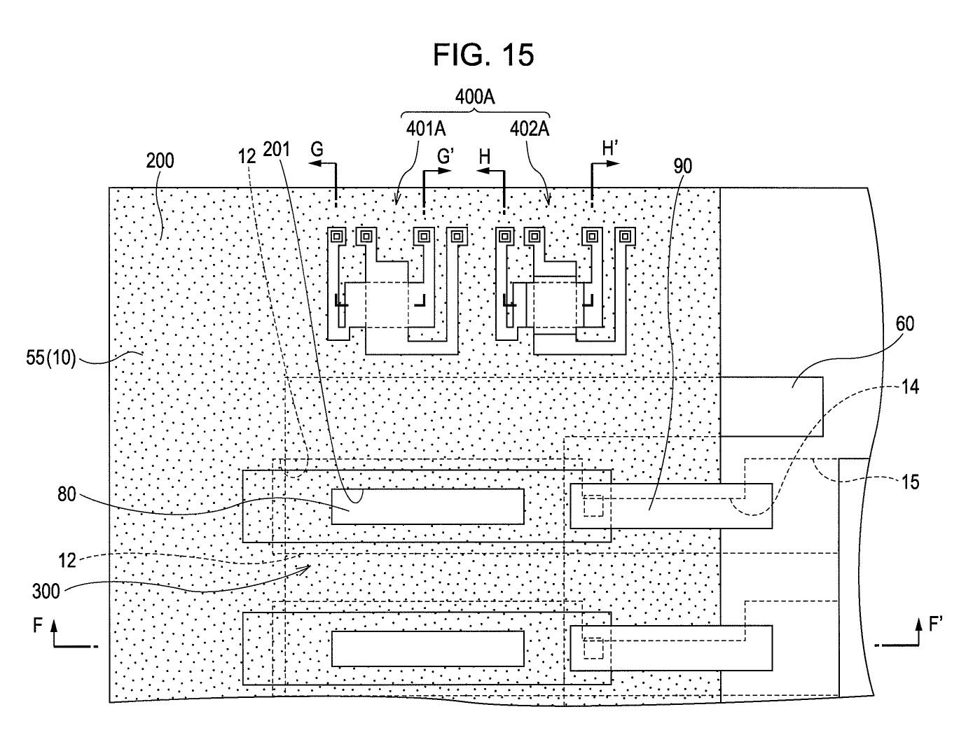

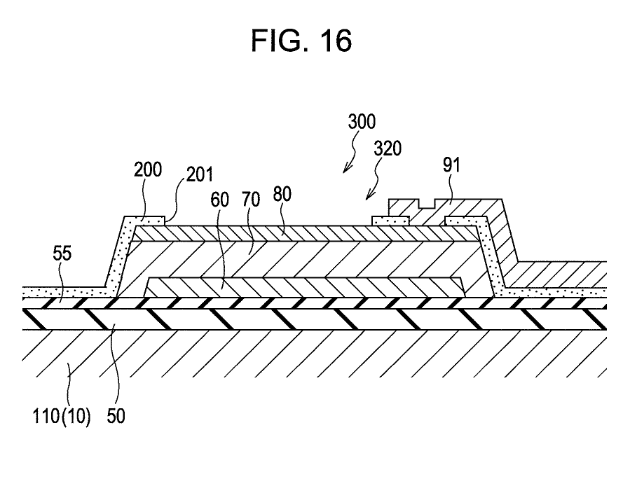

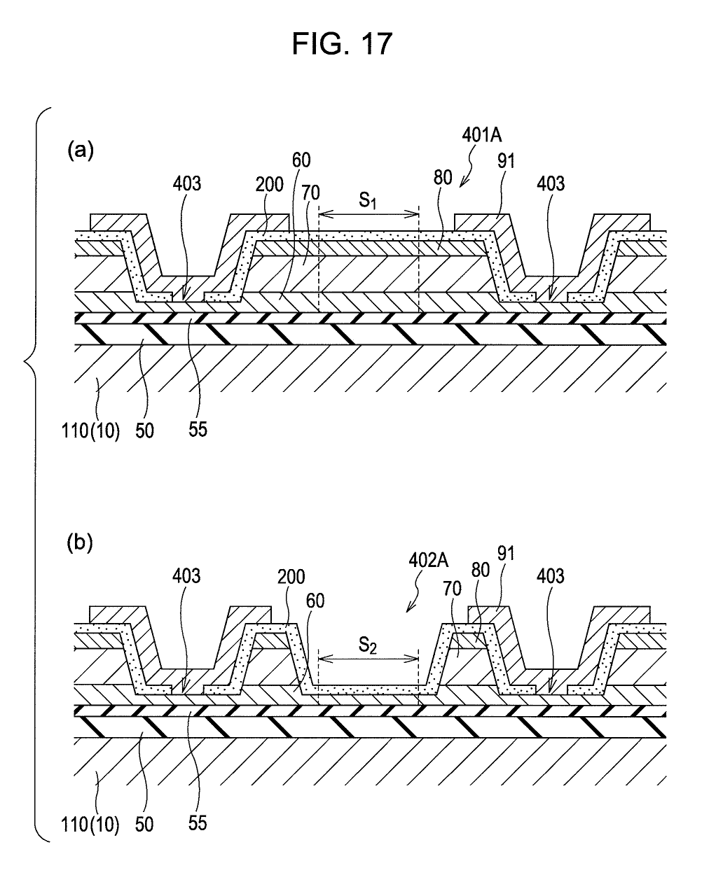

FIG. 15 is a plan view with essential part enlarged of an ink jet type recording head according to a second embodiment of the invention. FIG. 16 is a sectional view taken along the line F-F′ of FIG. 15. FIG. 17 is a sectional view taken along the line G-G′ of FIG. 15 and a sectional view taken along the line H-H′ of FIG. 15. The same parts as those in the foregoing first embodiment are represented by the same reference numerals, and overlap descriptions will be omitted.

As shown in FIGS. 15 and 16, the piezoelectric elements 300 are covered with a protective film 200 made of a moisture-resistant insulating material. In this embodiment, the protective film 200 is provided to cover the side surface of the piezoelectric material layer 70 and the side surface and an edge portion of the top surface of the upper electrode film 80, and to be continuous over a plurality of piezoelectric elements 300. The protective film 200 is not provided at a main portion that is substantially a central region of the top surface of the upper electrode film 80. An opening 201 is provided so as to expose the main portion of the top surface of the upper electrode film 80.

The openings 201 are formed to pass through the protective film 200 in its thickness direction and to have a rectangular shape along the longitudinal direction of each piezoelectric element 300. For example, the openings 201 may be formed by forming the protective film 200 on the entire surface of the flow channel forming plate 10 and selectively removing the protective film 200 by dry etching, such as ion milling or reactive dry etching.

If the piezoelectric element 300 is covered with the protective film 200, the piezoelectric element 300 can be prevented from being destroyed due to moisture in the atmosphere or the like. The protective film 200 may be made of a moisture-resistant material. For example, an inorganic insulating material, such as silicon oxide (SiOₓ), tantalum oxide (TaOₓ), aluminum oxide (AlOₓ), or the like, may be used. In particular, aluminum oxide (AlOₓ), which is an inorganic amorphous material, for example, alumina (Al₂O₃) is preferably used. When the protective film 200 is made of aluminum oxide, even if the protective film 200 has a comparatively small thickness of approximately 100 nm, it is possible to sufficiently suppress moisture permeation under the high humidity environment. In this embodiment, the protective film 200 is made of alumina (Al₂O₃).

If the openings 201 are provided in the protective film 200, the ink ejection characteristic can be satisfactorily maintained without interfering with the displacement of the piezoelectric elements 300 (active piezoelectric portion).

The protective film 200 may be provided to cover the surface of at least the piezoelectric material layer 70 of the piezoelectric element 300. Alternatively, the protective film 200 may be provided for each piezoelectric element 300 so as to be discontinuous over a plurality of piezoelectric elements 300.

The lead electrodes 90 are electrically connected to the upper electrode films 80 which are exposed through the openings 201.

The protective film 200 may be formed on the entire surface of the flow channel forming plate 10 after the lower electrode film 60, the piezoelectric material layer 70, and the upper electrode film 80 are sequentially laminated on the flow channel forming plate 10, and the upper electrode film 80 and the piezoelectric material layer 70 are patterned by etching to form the piezoelectric elements 300 and the test pattern 400. As described above, the openings 201 may be formed by dry-etching the protective film 200.

As shown in FIG. 15, a test pattern 400A has a first test pattern 401A and a second test pattern 402A. The first test pattern 401A and the second test pattern 402A have a cross shape in plan view, and extend to the end portion of the flow channel forming plate 10 in the arrangement direction of the piezoelectric elements 300.

As shown in FIG. 17(a), the first test pattern 401A has the lower electrode film 60 which is the same layer as the lower electrode film 60 serving as the common electrode of the piezoelectric elements 300 and electrically discontinuous with the lower electrode film 60, the piezoelectric material layer 70 which is the same layer as the piezoelectric material layer 70 of each piezoelectric element 300 and discontinuous with the piezoelectric material layer 70, the upper electrode film 80 which is the same layer as the upper electrode film 80 of each piezoelectric element 300 and electrically discontinuous with the upper electrode film 80, and the protective film 200. At the end portions of the first test pattern, removed portions 403 where the piezoelectric material layer 70, the upper electrode film 80, and the protective film are removed are provided. Test pattern lead wires 91 that are the same layer as the lead electrode 90 connected to each piezoelectric element 300 and electrically discontinuous with the lead electrode 90 are electrically connected to the lower electrode film 60 through the removed portions 403. Since the protective film 200 is formed after the first test pattern 401A is formed by patterning, the protective film 200 is provided at the end portions of the lower electrode film 60. The protective film 200 at the end portions of the lower electrode film 60 is removed simultaneously when the openings 201 are formed in the protective film 200, thereby forming the removed portions 403.

As shown in FIG. 17(b), the second test pattern 402A has the lower electrode film 60 which is the same layer as the lower electrode film 60 serving as the common electrode of the piezoelectric elements 300 and electrically discontinuous with the lower electrode film 60, the piezoelectric material layer 70 which is the same layer as the piezoelectric material layer 70 of each piezoelectric element 300 and discontinuous with the piezoelectric material layer 70, the upper electrode film 80 which is the same layer as the upper electrode film 80 of each piezoelectric element 300 and electrically discontinuous with the upper electrode film 80, and the protective film 200. The upper electrode film 80 and the piezoelectric material layer 70 in the cross intersection region S₂ of the second test pattern 402 are removed simultaneously when the piezoelectric elements 300 are etched. Therefore, the cross intersection region S₂ of the second test pattern 402 has the lower electrode film 60, which is overetched when the upper electrode film 80 and the piezoelectric material layer 70 are etched, and the protective film 200. At the end portions of the second test pattern 402A, similarly to the end portions of the first test pattern 401A, removed portions 403 where the piezoelectric material layer 70, the upper electrode film 80, and the protective film are removed are provided. Test pattern lead wires 91 that are the same layer as the lead electrode 90 connected to each piezoelectric element 300 and electrically discontinuous with the lead electrode 90 are electrically connected to the lower electrode film 60 through the removed portions 403.

With this configuration, similarly to the foregoing first embodiment, if electric resistance of the first test pattern 401A and the second test pattern 402A of the test pattern 400A is measured, electric resistance of the nonoveretched region S₁ of the lower electrode film 60 of the first test pattern 401A in the first state and electric resistance of the overetched region S₂ of the lower electrode film 60 of the second test pattern 402A in the second state can be measured. Therefore, the overetch amount of the lower electrode film 60 of the second test pattern 402A in the second state can be acquired. As a result, the overetch amount of the lower electrode film 60 serving as the common electrode of the piezoelectric elements 300 can be acquired.

Though not shown, if the test patterns 400A are provided at both end portions of the flow channel forming plate 10 in the arrangement direction of the piezoelectric elements 300, similarly to the foregoing first embodiment, the gradient (tendency) of the overetch amount of the lower electrode film 60 in the arrangement direction of the piezoelectric element 300 can be acquired.

### Other Embodiments

While embodiments of the invention have been described, the invention is not limited to the foregoing embodiment. For example, in the foregoing first or second embodiment, the test pattern 400 or 400A is provided to have a cross shape in plan view or has the extended end portions of the cross shape, but the shape and size of the test pattern is not particularly limited thereto.

In the foregoing first and second embodiments, the test pattern 400 or 400A that is used in manufacturing the head remains after the head is completed, but the invention is not particularly limited thereto. For example, after the overetch amount of the lower electrode film 60 is measured by the test pattern 400 or 400A, the test pattern 400 or 400A may be removed. That is, the test pattern 400 or 400A may be formed in an unnecessary portion of the wafer 110 for flow channel forming plates other than the regions where the chips are provided, such that the test pattern 400 or 400A may be removed simultaneously when the unnecessary portion is removed.

In the foregoing first and second embodiments, the test pattern 400 or 400A is formed in the region of the wafer 110 for flow channel forming plates where each flow channel forming plate 10 is provided, but the invention is not particularly limited thereto. For example, a single test pattern 400 or 400A may be formed for a plurality of flow channel forming plates 10, or a single test pattern 400 or 400A may be formed for each wafer 110 for flow channel forming plates.

In the foregoing first and second embodiments, the test pattern 400 or 400A having two test patterns of the first test pattern 401 or 401A in the first state and the second test pattern 402 or 402A in the second state is formed, and electric resistance of the first test pattern 401 or 401A and the second test pattern 402 or 402A are simultaneously measured, but the invention is not particularly limited thereto. For example, a single test pattern may be formed. In this case, let a first state be a state before the test pattern is etched together with the upper electrode film 80 and the piezoelectric material layer 70, then electric resistance of the lower electrode film of the test pattern in the first state is measured. Thereafter, let a second state be a state after the test pattern is etched together with the upper electrode film 80 and the piezoelectric material layer 70, electric resistance of the lower electrode film of the test pattern in the second state is measured. That is, electric resistance may be measured before and after the single test pattern is etched together with the upper electrode film 80 and the piezoelectric material layer 70.

In the foregoing first and second embodiments, as the test pattern 400 or 400A, the first test pattern 401 or 401A and the second test pattern 402 or 402A are provided, but the invention is not particularly limited thereto. For example, only the second test pattern 402 or 402A may be provided. In this case, electric resistance is calculated or actually measured from the thickness of the lower electrode film 60 before being etched together with the upper electrode film 80 and the piezoelectric material layer 70 and the area of the second test pattern 402 where electric resistance is measured, and is compared with electric resistance of the second test pattern 402 or 402A. In this way, the overetch amount of the lower electrode film 60 when the upper electrode film 80 and the piezoelectric material layer 70 are etched can be acquired. Of course, the second test patterns 402 or 402A may be provided at both end portions in the arrangement direction of the piezoelectric elements 300, or the second test pattern 402 or 402A may be provided only at one end portion in the arrangement direction of the piezoelectric elements 300. The thickness of the lower electrode film 60 before being etched may be a designed value when the lower electrode film 60 is formed by a sputtering process or a CVD process, or may be an actually measured value.

In the foregoing first and second embodiments, the flow channel forming plate 10 is made of a silicon monocrystal plate, but the invention is not particularly limited thereto. For example, the invention is effective for a SOI plate, a glass plate, a MgO plate, or the like. In addition, the elastic film 50 made of silicon dioxide is provided in the lowermost layer of the vibrating plate, but the configuration of the vibrating plate is not particularly limited thereto.

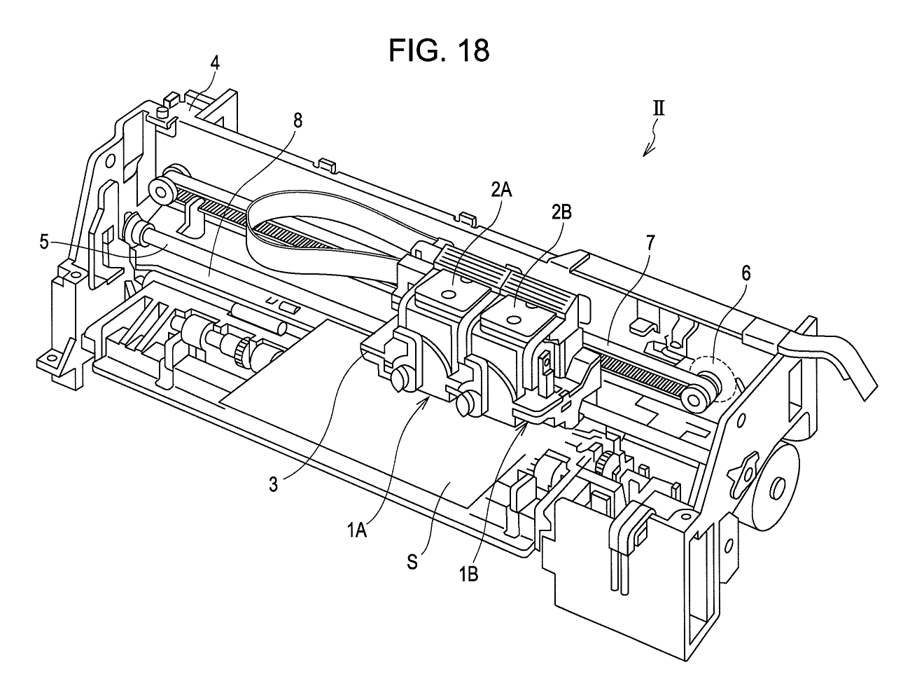

The foregoing ink jet type recording head I constitutes a part of a recording head unit having ink flow channels which communicate with ink cartridges or the like, and is mounted on an ink jet type recording apparatus. FIG. 18 is a schematic view showing an example of such an ink jet type recording apparatus.

In an ink jet type recording apparatus II shown in FIG. 18, recording head units 1A and 1B each having an ink jet type recording head I are configured such that cartridges 2A and 2B constituting an ink supply unit are detachably provided. A carriage 3 on which the recording head units 1A and 1B are mounted is provided so as to freely move along a carriage shaft 5 attached to an apparatus main body 4. The recording head units 1A and 1B eject, for example, a black ink composition and a color ink composition, respectively.

If a driving force of a driving motor 6 is transmitted to the carriage 3 through a plurality of gears (not shown) and a timing belt 7, the carriage 3 with the recording head units 1A and 1B mounted thereon moves along the carriage shaft 5. Meanwhile, a platen 8 is provided in the apparatus main body 4 along the carriage shaft 5, and a recording sheet S that is a recording medium, such as paper or the like, fed by a paper feed roller (not shown) is wound around the platen 8 and transported.

In the above-described ink jet type recording apparatus II, the ink jet type recording head I (the head units 1A and 1B) is mounted on the carriage 3 and moves in the main scanning direction, but the invention is not particularly limited thereto. For example, the invention may be applied to a line type recording apparatus in which printing is performed by moving the recording sheet S, such as paper or the like, in the sub scanning direction in a state when the ink jet type recording heads I is fixed.

While in the foregoing examples, a case in which an ink jet type recording head is used as an example of liquid jet heads and an ink jet type recording apparatus is used as an example of liquid jet apparatuses has been described, the invention is intended for all kinds of liquid jet heads and liquid jet apparatuses, and of course, it may be applied to a liquid jet head or a liquid jet apparatus that ejects a liquid other than ink. Other examples of the liquid jet head include, for example, various recording heads used in an image recording apparatus, such as a printer or the like, a color material jet head used in manufacturing a color filter for a liquid crystal display or the like, an electrode material jet head used in forming electrodes for an organic EL display, an FED (Field Emission Display), or the like, a bio-organic material jet head used in manufacturing a biochip. The invention may be applied to a liquid jet apparatus having such a liquid jet head.

The invention is not limited to a method of manufacturing an actuator apparatus mounted on a liquid jet head, for example, an ink jet type recording head, and it may be applied to a method of manufacturing an actuator apparatus mounted on other apparatuses.

What is claimed is:

1. A method of manufacturing an actuator, the method comprising:
laminating a lower electrode, a piezoelectric material layer, and an upper electrode on one surface of a base plate;
simultaneously etching the upper electrode and the piezoelectric material layer to form a piezoelectric element;
forming, on the base plate, a test pattern that is electrically discontinuous with the electrodes of the piezoelectric element and has the same layer as the lower electrode, the test pattern having the lower electrode with the upper electrode and the piezoelectric material layer removed by etching; and
measuring electric resistance of the lower electrode of the test pattern to acquire an etch amount of the lower electrode when the piezoelectric element is formed.

2. A method of manufacturing an actuator including the manufacturing method according to claim 1,
wherein the lower electrode of the test pattern is formed to have a cross shape, a current flows in a pair of adjacent terminals of the lower electrode, and a potential difference between other terminals is measured to measure electric resistance.

3. A method of manufacturing an actuator including the manufacturing method according to claim 1,
wherein a plurality of piezoelectric elements are arranged in parallel on the base plate, and test patterns are at both end portions in the arrangement direction of the piezoelectric elements.

4. A method of manufacturing an actuator including the manufacturing method according to claim 1,
wherein in the measuring of the etch amount of the lower electrode, electric resistance of the lower electrode is measured in a first state, in which the test pattern is electrically discontinuous with the electrodes of the piezoelectric element and has the same layer as the lower electrode, and the piezoelectric material layer and the upper electrode are formed, and electric resistance is measured in a second state, in which the test pattern has the lower electrode with the upper electrode and the piezoelectric material layer are etched simultaneously with the piezoelectric element, and the etch amount of the lower electrode is acquired on the basis of electric resistance in the first state and electric resistance in the second state.

5. A method of manufacturing an actuator including the manufacturing method according to claim 1,
wherein the test pattern in the first state and the test pattern in the second state are formed simultaneously with the piezoelectric element.

6. A method of manufacturing an actuator including the manufacturing method according to claim 1,
wherein the etch amount acquired in the acquiring of the etch amount of the lower electrode is fed back to control an etch amount of the upper electrode and the piezoelectric material layer.

7. A method of manufacturing a liquid jet head, the method comprising:
the method of manufacturing an actuator according to claim 1; and
forming the actuator apparatus on one surface of a flow channel forming plate, in which a pressure generation chamber is provided to communicate with a nozzle opening jetting a liquid.

8. A liquid jet apparatus comprising a liquid jet head obtained by the method of manufacturing a liquid jet head according to claim 7.
